(19) United States
(12) Patent Application Publication
(10) Pub. No.: US 2022/0127535 A1
(43) Pub. Date: Apr. 28, 2022

(54) Magnetic hydrocarbon fuel treatment device and method

(71) Applicant: Gordon Thomas Kaitting, Oakville (CA)

(72) Inventor: Gordon Thomas Kaitting, Oakville (CA)

(21) Appl. No.: 16/974,151

(22) Filed: Oct. 23, 2020

(51) Int. Cl. C10G 32/02; F02M 27/04; C10L 1/04; F23K 5/00

(52) U.S. Cl. CPC C10G 32/02; F02M 27/045; C10L 1/04; F23K 5/007; F23K 2400/20; C10L 2290/40; C10G 2300/201; C10G 2300/207; C10L 2230/22

(57) ABSTRACT

Magnetic treatment of hydrocarbon fuel flowing through a fuel conduit. A plurality of magnets with repelling polarity affects the fuel structure and alternating said structure by aligning the hydrocarbons in a parallel uniform manner to increase combustion efficiency, thus increasing power while reducing pollutants and exhaust emissions.

### RELATED APPLICATIONS

The present application is related to the U.S. Pat. No. 4,568,901, issued Feb. 4, 1986, included by reference herein.

The present application is related to the U.S. Pat. No. 4,808,306, issued Feb. 28, 1989, included by reference herein.

The present application is a continuation-in-part application of U.S. provisional patent application, Ser. No. 51/29,382, filed Jul. 14, 1992, included by reference herein and for which benefit of the priority date is hereby claimed.

The present application is related to the U.S. Pat. No. 5,637,226, issued Jun. 10, 1997, included by reference herein.

The present application is related to the U.S. Pat. No. 5,943,998, issued Aug. 31, 1999, included by reference herein.

The present application is related to the U.S. Pat. No. 6,971,409, issued Dec. 6, 2005, included by reference herein.

The present application is related to the U.S. Pat. No. 4,572,145, issued Feb. 25, 1984, included by reference herein.

The present application is related to the U.S. Pat. No. 51,24,045, issued Jun. 23, 1992, included by reference herein.

The present application is related to the U.S. Pat. No. 5,359,979, issued Nov. 1, 1994, included by reference herein.

The present application is related to the U.S. Pat. No. 5,816,227, issued on Oct. 6, 1998, included by reference herein.

The present application is related to the U.S. Pat. No. 6,890,432, issued May 10, 2005, included by reference herein.

The present application is a continuation-in-part application of U.S. provisional patent application, Ser. No. 7,004,153, filed Feb. 28, 2006, included by reference herein and for which benefit of the priority date is hereby claimed.

### FIELD OF THE INVENTION

The present invention relates to fuel treatment and enhancement devices and, more particularly, to magnetic hydrocarbon treatment devices and methods.

### BACKGROUND OF THE INVENTION

Hydrocarbon fuels lack stability, and the variability of the stability of these hydrocarbon fuels fluctuates due to storage conditions, refining methods, transportation methods, and environmental conditions resulting in a clustering of molecules; as the clustering of molecules increases, the burn ability of the fuels decreases. Fuel efficiency drops, maintenance issues increase, and an overall lack of efficiency besets the systems using these fuels as their energy source. This activity is compounded through introduced bio-organisms such as bacteria, molds, fungus, and other microbial activity. But much of it results from polymerization and agglomerations of the organic compounds in the hydrocarbon fuels. The problem has been on how to prevent and or correct these issues and stabilize the fuels until they can be burned.

Early users of these and similar fuels were not faced with the issues of today, such as very high cost and shortage of resources coupled with environmental issues concerning the emission of dangerous and harmful toxins and chemicals into the atmosphere. People were both unconcerned and unaware of the health consequences that were caused by these emissions. Until recently, they were unaware of the additional maintenance costs resulting from the pollution of other electronic systems and even the cleaning of buildings from the discoloration effect that these emissions caused. There are both primary and secondary negative circumstances caused by the volume of emissions created by the burning of hydrocarbon fuels.

Today's economy and environmental concerns and costs do not permit the operation of hydrocarbon systems as they have in the past.

A great many methods have been tried to reduce the problems previously mentioned. They include magnetic devices of varying configurations, filters of all types, flue scrubbers that clean or collect exhaust emissions, or at least part of the particulates that otherwise would be sent into the atmosphere, causing pollution of various sorts. Other solutions include fuel additives, blending of various combinations of fuels and additives temperature treatments, and other novel methods.

The search for solutions is ongoing and properly so since no one perfect solution has yet been found. Improvement in this area is ongoing in the attempt to find ever better ways to improve fuel efficiency while reducing combustion emissions and their hazards.

Other systems such as flue scrubbers are costly to install and maintain, and yet again, there is the issue of the particulates they have collected and how to deal with their disposal. This creates a condition where costs rise, and pollution issues have been deferred rather than reduced.

Some of the others, such as catalytic converters, eliminate the problems of pollution and reduce fuel costs, but their installation is expensive and limited in scope. They are not suitable for the most aftermarket or retrofit situations, so do not address the billions of tons of fuels currently being consumed in devices that are not fitted with them. Moreover, none of these mechanical devices treats the fuel before it is burned to increase fuel efficiency and reduce its emissions.

In conclusion, these present devices do not make the treatment of hydrocarbon fuels economic, convenient, or efficient. Therefore, they are used primarily only where emission reduction is mandated by law rather than employed because of the economic advantages that a new device would impart.

It is, therefore, an object of the invention to increase fuel efficiency.

It is another object of the invention to decrease combustion emissions.

It is another object of the invention to reduce maintenance costs.

It is another object of the invention to reduce the combustion chamber size.

It is another object of the invention to fuel storage size.

It is another object of the invention to increase burn temperatures.

It is another object of the invention to reduce burn times.

### SUMMARY OF THE INVENTION

In accordance with the present invention, there is provided a magnetic treatment of hydrocarbon fuel flowing through a fuel conduit. A plurality of magnets with repelling polarity affects the fuel structure and alternating said structure by aligning the hydrocarbons in a parallel uniform manner to increase combustion efficiency, thus increasing power while reducing pollutants and exhaust emissions.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a fuel line fitted with ceramic magnets arranged to affect the structure of the carbon and hydrogen molecules flowing through the fuel line;

FIG. 2 is a perspective view of a fuel line detailing the change in the hydrogen and carbon molecules after being affected by the ceramic magnets;

FIG. 3 is a perspective view of a combustion furnace retrofitted with a magnetic hydrocarbon treatment device; and

FIG. 4 is a perspective view of an oil derrick retrofitted with a magnetic hydrocarbon treatment device.

For clarity and brevity, like elements and components, will bear the same designations and numbering throughout the Figures.

### DESCRIPTION OF THE PREFERRED EMBODIMENT

Hydrocarbons in the gas are agglomerated in the pipeline due to the van der Waals force. When burning in a state of agglomeration, combustion will be insufficient. If a magnetic field magnetizes these agglomerated molecules, the molecules will be “activated,” the intermolecular force will be reduced and dispersed, and then the combustion efficiency will be increased.

Fuel, after magnetization, has no agglomeration of hydrocarbons, so it is more sufficient in the combustion process. There are only water and carbon dioxide in the product, while there is a lot of carbon in the product without magnetization.

This study aimed to investigate the effect of a magnetized fuel on the performance of the fuel combustion in the boiler. The performance was observed by examining fuel consumption and exhaust emissions; in this experimental work, we are using a diesel fuel that is subjected to a magnetic field that is placed on the fuel supply line to magnetize the fuel before admitted to the burner of the boiler. The magnetic field used in this study is coming from two permanent magnets, each with (2000 Gauss).

The experimental result shows an improvement in boiler performance after the fuel is subjected to a magnetic field. The fuel consumption is decreased by (3.675%). The exhaust gas emission showed a reduction nearly by (38.04%) in CO, (21.89%) in HC. An increase by (3.432%) in CO2 and by (4.34%) in the exhaust temperature was observed.

The conventional boiler, which runs on the combustion of diesel fuel, has been around for two centuries. The external combustion engine has a huge role in generating steam in a power plant for its speed, high efficiency, and the low cost to run. The diesel combustion fuel is the industry's leading prime mover and will likely remain for the foreseeable future. To keep using this fuel, it has become imperative to improve the fuel consumption and emission characters.

Many experimental studies presented evidence of the benefits of magnetic treatment, which will enhance the fuel economy and reducing exhaust emission.

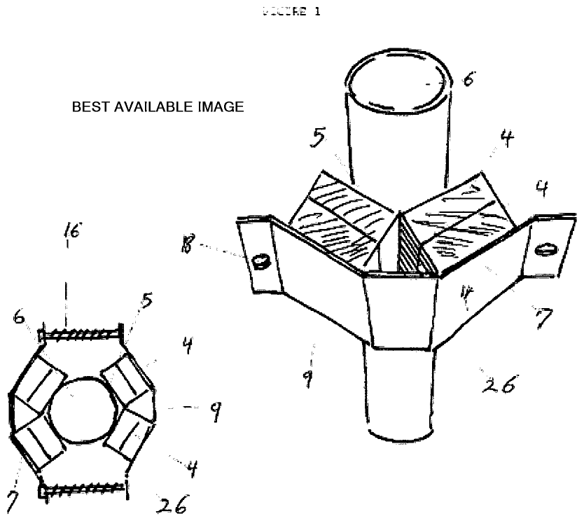

Referring now to FIG. 1, in accordance with a preferred embodiment of the present invention generally concerns a fuel treatment system wherein the system preferably comprises a ceramic magnet 4 mounted with its south polarity 5 directly against a fuel conduit 6 with a plurality of additional ceramic magnet 4 (s) fitted circularly around the same fuel conduit 6 with all conduit contact sides providing a south polarity 5 ensuring an opposing force on all sides of the fuel conduit 6. The generally rectangular prismatic shaped ceramic magnet 4 is made of strontium carbonate and iron oxide and sized to fit the variables of the fuel conduits dimensions. A permanently attached metal backing 14 in contact with the north polarity 7 of the magnets provides shape for placement and rigidity and fastenability of the opposing magnetic sections 9. Sections are fastened using a standard hardware fastener 16, such as a threaded bolt passing through a formed flange at the end of each rectangular-shaped metal backing 14 fitted with a fastener hole 18 in each flange as opposed to a fastener hole 18 in an opposing flange.

In operation, more than one set of magnets may be stacked upon the other resulting in a stronger magnetic effect upon the fuel conduit 6. The present invention may also be applied linearly to affect a significant length of the fuel conduit 6.

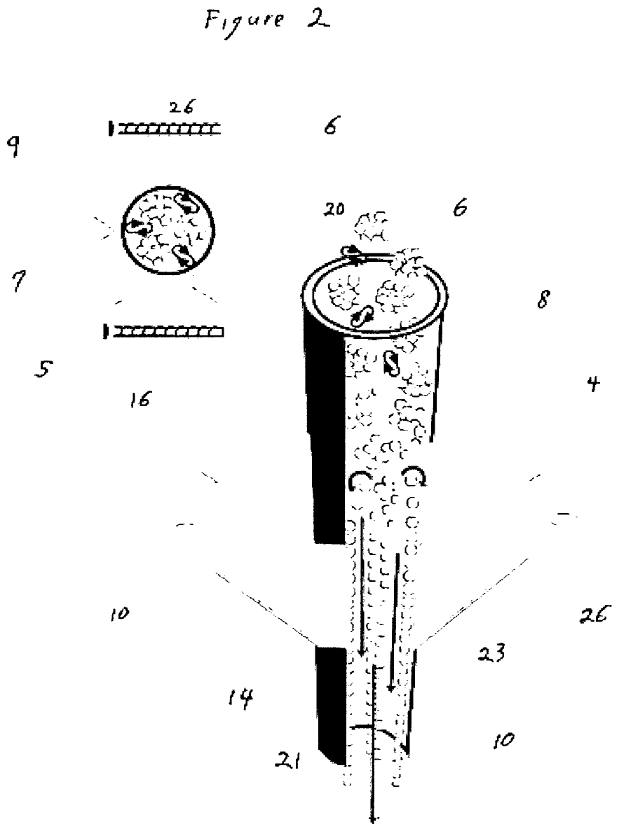

Referring now to FIG. 2, in accordance with a preferred embodiment of the present invention, it shall be understood that the carbon atoms 23 and hydrogen atoms 21 moves through the fuel conduit 6 from the fuel source side 8 as clusters 20 past the mounted present invention whereby the negative polarity causes the hydrogen atoms 21 and carbon atoms 23 to separate and align with like atoms. In a most preferred embodiment of the present invention, ceramic magnet 4 mounted with its south polarity 5 directly against a fuel conduit 6 with a plurality of additional ceramic magnet 4 (s) fitted circularly around the same fuel conduit 6 with all conduit contact sides providing a south polarity 5 ensuring an opposing force on all sides of the fuel conduit 6 causing the positively charged carbon atoms 23 to travel to the outside of the fuel conduit 6. In contrast, the negatively charged hydrogen atoms 21 are pushed to the center, allowing for separated atoms 22 for easier combining of introduced oxygen 30 with the hydrogen atoms 21 for complete combustion as the fuel passes the magnetic hydrocarbon treatment device 26 and moves toward the fuel outlet direction 10.

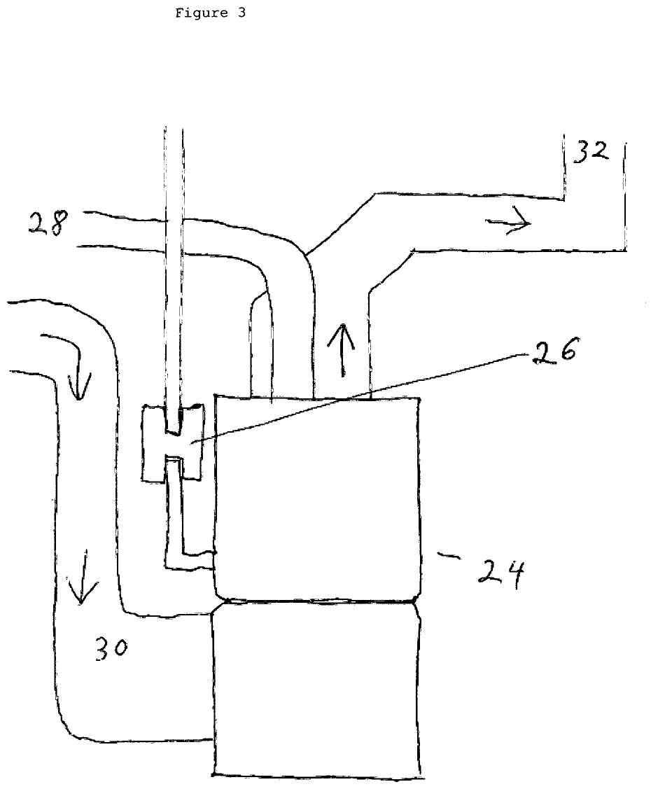

Referring now to FIG. 3, in accordance with a preferred embodiment of the present invention, the magnetic hydrocarbon treatment device 26 is mounted immediately upstream from the combustion unit on the fuel conduit 6, affecting the temperature and pollutants in the flue exhaust 28.

In operation, the effects of the present invention result in incomplete combustion, so increase the flue temperature while reducing the particulate matter emitted from the furnace 24. In the case of a furnace, 24 depicted the output heat 32 temperature is increase by some 10 to 20% resulting in greater fuel efficiency while at the same time reducing the amount of unburned fuels and thus reducing the amount of expelled pollutants into the atmosphere. The effect varies depending upon the device. The units are attached too. For example, in a boiler, the temperature may not increase because the rate of fuel consumption will be adjusted down, thus saving fuel while maintaining the appropriate temperature. In others, the temperature may rise, so the burn time is shortened, where thermostats determine to burn and rest times for a device. In yet other situations, the only effect may be to reduce the expelled pollutants by providing for a more efficient burn. In contrast, temperature or burn time is not an issue such as in a well burn off, and in yet another instance, the present invention may be applied to a pipeline designed to transport raw fuel such as crude oil as a means to increase the flow rate of the crude oil with no imminent intention to combust.

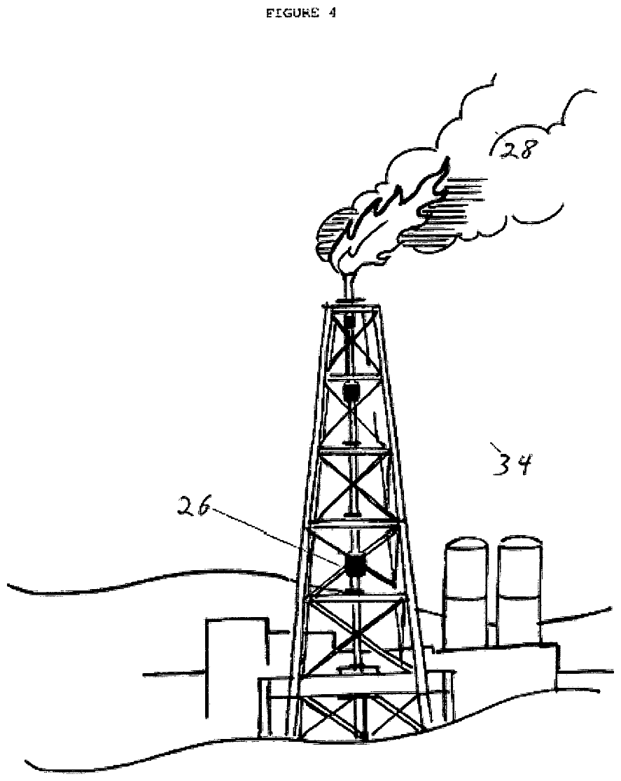

Referring now to FIG. 4, in accordance with a preferred embodiment of the present invention, the magnetic hydrocarbon treatment device 26 is mounted immediately upstream from the combustion unit on the fuel conduit 6 of an oil derrick 34 with burnt gases 36 being expelled.

In operation, the present invention reduces pollutants being expelled into the atmosphere with no regard to burn time or specific temperature output.

It should be understood that the descriptions refer to the most preferred embodiment and it should be recognized that many minor changes in shape and mounting may be used to achieve the same results as described and that this description is not meant to limit the variability but rather to provide a reasonable understanding of the invention, its application, and methods.

Since other modifications and changes varied to fit particular operating requirements and environments will be apparent to those skilled in the art, the invention is not considered limited to the example chosen for purposes of disclosure. It covers all changes and modifications which do not constitute departures from the true spirit and scope of this invention.

Having thus described the invention, what is desired to be protected by Letters Patent is presented in the subsequently appended claims.

What is claimed is:

1. A magnetic hydrocarbon treatment device and method for magnetic treatment of hydrocarbon fuel flowing through a fuel conduit for greater fuel efficiency and reduced emissions, comprising: means for pulling the positively charged carbon atoms to the outside of the pipe while pushing the negatively charged hydrogen atoms to the center;
means for permitting the application of the magnets in a uniform and consistent manner to the fuel conduit;
means for correctly positioning and maintaining the magnets in their proper relationship to the fuel line;
means for greater fuel efficiency and reduction of harmful pollutants;
means for separating the carbon and hydrogen elements for greater fuel efficiency and lower pollution; and
means to reduce the emissions of the flu gases eliminating many of the pollutants emitted into the atmosphere.

2. The magnetic hydrocarbon treatment device and method in accordance with claim 1, wherein said means for pulling the positively charged carbon atoms to the outside of the pipe while pushing the negatively charged hydrogen atoms to the center comprises a high intrinsic coercive force, ferrite, low-temperature service, grade 5 through 8 ceramic magnets.

3. The magnetic hydrocarbon treatment device and method in accordance with claim 1, wherein said means for permitting the application of the magnets in a uniform and consistent manner to the fuel conduit comprises a cluster of magnets, rigid magnetic sections.

4. The magnetic hydrocarbon treatment device and method in accordance with claim 1, wherein said means for correctly positioning and maintaining the magnets in their proper relationship to the fuel line comprises a rigid metal backing.

5. The magnetic hydrocarbon treatment device and method in accordance with claim 1, wherein said means for greater fuel efficiency and reduction of harmful pollutants, comprises a sorted to type separated atoms.

6. The magnetic hydrocarbon treatment device and method in accordance with claim 1, wherein said means for separating the carbon and hydrogen elements for greater fuel efficiency and lower pollution, comprises magnetized elements of carbon and hydrogen magnetic hydrocarbon treatment device.

7. The magnetic hydrocarbon treatment device and method in accordance with claim 1, wherein said means for the reduction of the emissions of the flu gases eliminating many of the pollutants emitted into the atmosphere comprises un-combusted fuels, pollutants flue exhaust.

8. A magnetic hydrocarbon treatment device and method for magnetic treatment of hydrocarbon fuel flowing through a fuel conduit for greater fuel efficiency and reduced emissions, comprising: a high intrinsic coercive force, ferrite, low-temperature service, grade 5 through 8 ceramic magnets, for pulling the positively charged carbon atoms to the outside of the pipe while pushing the negatively charged hydrogen atoms to the center;
a cluster of magnets, rigid magnetic sections, for permitting the application of the magnets in a uniform and consistent manner to the fuel conduit;
a rigid metal backing for correctly positioning and maintaining the magnets in their proper relationship to the fuel line;
a sorted to type separated atoms, for greater fuel efficiency and reduction of harmful pollutants;
magnetized elements of carbon and hydrogen magnetic hydrocarbon treatment device, for separating the carbon and hydrogen elements for greater fuel efficiency and lower pollution; and
un-combusted fuels, pollutants flue exhaust, for reducing the emissions of the flu gases eliminating many of the pollutants emitted into the atmosphere.

9. A magnetic hydrocarbon treatment device and method for magnetic treatment of hydrocarbon fuel flowing through a fuel conduit for greater fuel efficiency and reduced emissions, comprising: a high intrinsic coercive force, ferrite, low-temperature service, grade 5 through 8 ceramic magnets, for pulling the positively charged carbon atoms to the outside of the pipe while pushing the negatively charged hydrogen atoms to the center;
a cluster of magnets, rigid magnetic sections, for permitting the application of the magnets in a uniform and consistent manner to the fuel conduit;
a rigid metal backing for correctly positioning and maintaining the magnets in their proper relationship to the fuel line;
a sorted to type separated atoms, for greater fuel efficiency and reduction of harmful pollutants;
a magnetized elements of carbon and hydrogen magnetic hydrocarbon treatment device, for separating the carbon and hydrogen elements for greater fuel efficiency and lower pollution; and
a un-combusted fuels, pollutants flue exhaust, for reducing the emissions of the flu gases eliminating many of the pollutants emitted into the atmosphere.
